(19) United States
(12) Patent Application Publication
(10) Pub. No.: US 2020/0191111 A1
(43) Pub. Date: Jun. 18, 2020

(54) WAVE ENERGY HARVESTER WITH THREE DEGREES OF FREEDOM

(71) Applicant: LEVIATHAN ENERGY L.L.C., Lawrence, NY (US)

(72) Inventors: Mark Daniel Farb, Beit Shemesh (IL); Anurag PURWAR, Stony Brook, NY (US); Banu SAJJA, Hicksville, NY (US)

(21) Appl. No.: 16/643,565

(22) PCT Filed: Aug. 29, 2018
(86) PCT No.: PCT/IL2018/050957

§ 371 Date: Mar. 1, 2020

(30) Foreign Application Priority Data
Sep. 3, 2017 (US) 62553851

(51) Int. Cl. F03B 13/20

(52) U.S. Cl. CPC F03B 13/20; F05B 2250/43; F05B 2250/23

(57) ABSTRACT

Irregular motion of waves creates a challenge to obtain energy efficiently. Heave type devices have been found to have high efficiencies, but they are limited to capturing energy along one or two directions of freedom. A new system and method for obtaining energy from the heaving motion of the waves is presented. It consists of base and heave structures connected through arm devices comprising three degrees of freedom, said arms powered by the motion of the heave structure in the fluid. These arm devices allow capture of wave energy by mechanical, hydraulic, or pneumatic systems.

### STATEMENT REGARDING PRIOR DISCLOSURES BY THE INVENTOR OR A JOINT INVENTOR

This patent application claims the benefit of U.S. Provisional Patent Application No. 62/553,851 entitled Wave Energy Harvester with 3 Points of Freedom, filed Sep. 3, 2017.

### CROSS REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not applicable

### BACKGROUND OF THE INVENTION

The present invention relates to a new concept for obtaining energy from ocean waves. It involves at least 2, preferably 3 mechanisms of attachment called arm devices, between 2 structures, one of which is moved by the waves. These arm devices ideally comprise 3 joints and 2 arms. Providing 3 arm devices between 2 structures is the ideal configuration.

Definitions: A revolute joint is also called a rotational joint. A prismatic joint is also called a sliding joint. An arm is the tubular structure attached on each side to a joint. An arm device refers to the combination of 2 arms and 3 joints. The 3 joints provide 3 degrees of movement freedom.

There are several categories of invention for obtaining energy from ocean waves. One of the most efficient types has been the heave variety, one of which is known as Salter's duck, shown in FIG. 4 from http://www.jeron.je/anglia/learn/sec/science/sn005/page02.htm According to Wikipedia, the wave impactnduces rotation of gyroscopes located inside a pear-shaped “duck”, and an electrical generator converts this rotation into electricity with high efficiency. However, it cannot adjust to greater size heaves, so it may have high efficiency only in a limited range of the wave motion.

A related device is the category of oscillating wave surge converter. These devices typically have one end connected to a structure or the seabed while the other end is free to move. The arm oscillates as an inverted pendulum mounted on a pivoted joint in response to the movement of water in the waves. Energy is collected from the relative motion of the body with respect to the connected point. FIG. 5 shows an example in the Oyster wave converter. It operates as a single degree of freedom device. It only takes advantage of the vertical motion of the wave.

Surface attenuators operate to some extent by heave. Attenuator devices are relatively long in length (up to 150 m) as compared to ocean wavelengths, and are typically positioned in parallel to the general direction of wave propagation. Attenuators consist of multiple buoyant segments that articulate as wave crests and troughs pass. Mechanical energy is extracted from the relative motion of each segment, usually though the compression of a fluid in hydraulic pistons. Attenuators can be designed to float freely and operate at the water's surface or can be arranged to articulate in reaction to a connected structure attached to the ocean floor. The most notable surface attenuator WEC is the Pelamis. These systems are very inefficient.

Another example of a heave structure is U.S. Pat. No. 9,169,823 B2. It is a device for generating electricity that includes a buoyant structure, a heave plate, at least one load carrying structure that is mechanically coupled to both the buoyant structure and the heave plate, and at least one magnetostrictive element. The magnetostrictive element is configured to experience force changes applied by the load carrying structure caused by hydrodynamic forces acting on the device. It is shown in FIG. 6. This device, in comparison to the current invention, lacks joints, and lacks three degrees of freedom.

| WEC US 9,169,823 B2 | Current Application |
|---|---|
| The device uses a floating buoyant | We use a floating structure which is |
| structure which is attached to a heaving | attached to a base plate using |
| plate by magnetostrictive elements and | mechanical linkages such as sliding or |
| load carrying elements | rolling joints |
| The floating structure has 3 points of | The floating structure has 3 points of |
| connection to the heaving plate | connection to the base plate |
| The device has a cylindrical buoy as | We use any appropriate shape as a |
| floating structure | floating element |
| The device uses a heave plate in order to | We connect the base plate either by |
| damp the heave response of the body | using a pile attached to the seabed or by |
| | using mooring lines |
| The force changes in the load carrying structures | The movement of the hydraulic pistons due to the |
| between the heave plate and the float create current | relative movement of the float with respect to |
| flow in the magnetostrictive elements | the base plate creates pressurized fluid |
| | which can be used to produce power, |
| | but we are not limited to |
| | that way of generating power. |

U.S. Pat. No. 4,631,921 describes, as shown in FIG. 7, a float for supporting a submerged wave energy harvesting device that includes a conical member which is buoyant on the surface of the body of water. The conical member rocks or otherwise moves in response to wave motion on the surface of the body of water. An electrical generator is located within the interior of the conical member and is connected to the device. Supplemental positioning floats each connected to an anchor can be positioned in a geometrical configuration around the conical member with a tether connected between the conical member and each of the supplemental floats to maintain both the conical member and the device in a fixed position with respect to the ocean floor.

| WEC 4,631,921 | Our Device |
|---|---|
| The device has a conical floating | We use a floating structure which is |
| structure which is attached to | attached to a base plate using |
| a generator via a shaft | mechanical linkages such as |
| | prismatic or rolling joints |
| The conical structure has 3 | The floating structure has 3 points |
| points of connection to the | of connection to the base plate |
| floatation system | |
| The device has a conical buoy | We use a triangular structure as a |
| as floating structure | floating element |
| The device uses hydraulic | We use hydraulic pistons to pump |
| turbines to generate power | hydraulic fluid into turbine |

Current technologies utilize either one or two degrees of freedom of the wave in order to harvest the energy. A device having three degrees of freedom in a connected plane is the ideal way to harness energy for heave, surge, and pitch, as the device can adjust and orient itself according to the wave characteristics. In this device, there a moving platform connected to a base (or, fixed) platform via three arm devices (or, kinematic chain) each of single degree of freedom consisting of a trio of revolute, “R”, (rotational) or prismatic, “P”, (sliding) joints. Consequently each of the independent kinematic chains can be denoted by a set of three letters indicating the succession of joints starting from the ground. A revolute joint (also called pin joint or hinge joint) is a one-degree-of-freedom kinematic pair used in mechanisms. Revolute joints provide single-axis rotation function used in many places such as door hinges, folding mechanisms, and other uni-axial rotation devices. A prismatic joint provides a linear sliding movement between two bodies, and is often called a slider, as in the slider-crank linkage. A prismatic joint can be formed with a polygonal cross-section to resist rotation. For example, if a serial chain is PRR, there is a prismatic joint at A and there are two revolute joints at B and C (joint connected to the moving platform) respectively, in FIG. 8. The possible combinations of Revolute (R) and Prismatic (P) joints in a PPM are RRR, RRP, RPR, RPP, PRR, PRP, PPR. The PPP chain is not useful and must be excluded because only two planar P joints in a chain are independent, and hence it only translates with no change in orientation. Hence, there are seven possible useful kinematic chains. See FIG. 9. Power produced by the moving platform is equal to the sum of all the individual powers produced at each of the actuated joints.

It was found by simulation that the best position of the device is for the heave structure to be immersed into the water such that the incoming wave height completely submerges its top surface.

The invention can be customized to the prevailing wave situation in each area, as the flow chart in FIG. 10 shows. (WEC=Wave Energy Converter. AQWA is a software package.)

### BRIEF SUMMARY OF THE INVENTION

The present invention successfully addresses the shortcomings of the presently known configurations by providing a 3-points-of-freedom device to obtain energy from waves. The energy is transformed into useful form through hydraulics or motion in most cases.

It is now disclosed for the first time a system for obtaining energy from waves, comprising: a base structure, with at least two sides, fixed to a base in or adjacent to waves, a floating heave structure, with at least two sides, at least two arm devices, each arm device comprising:

a base joint of either the prismatic or revolute types attached to a side of the base structure facing the heave structure,

a heave joint of either the prismatic or revolute types attached to a side of the heave structure facing the base structure, said heave joint corresponding substantially to positions of the base joints on the base structure,

each base joint is attached to a base arm,

each heave joint is attached to a heave arm,

each pair of base and heave arms is attached to a middle joint;

each said arm device is connected to at least one generator system, said generator system defined as any mechanism that results in energy production, such as hydraulic or electrical, from the motion of the arm device.

In one embodiment, the system further comprises 3 arm devices.

In one embodiment, the system of 2 or 3 arm devices further comprises at least one generator system comprising a hydraulic mechanism containing a compressible fluid, said fluid compressed by the motion of the arms and joints.

According to another embodiment of the system of 2 or 3 arm devices, at least one arm device comprises an electric generator, operating from rotational motion of the joint.

According to another embodiment of the system of 2 or 3 arm devices, the base structure is below the heave structure.

According to another embodiment of the system of 2 or 3 arm devices, the base structure is between the upper part of the wave on the surface and the lower point of the wave, beneath the surface.

According to another embodiment of the system of 2 or 3 arm devices, the base structure is adjustable in height above the sea floor while fixed to a supporting object.

In one embodiment, the system further comprises a second heave structure attached by arm devices to a second side of the base structure.

According to another embodiment of the system of 2 or 3 arm devices, the heave structure is substantially planar.

According to another embodiment of the system of 2 or 3 arm devices, the heave structure is a polygonal structure.

According to another embodiment of the system of 2 or 3 arm devices, at least one part of the heave structure is concavely cupped in the area of impact of the wave on the heave structure,

According to another embodiment of the system of 2 or 3 arm devices, a length of the heave structure is equal to or a little greater than the wavelength of the wave. (This may be a more efficient configuration.)

According to another embodiment of the system of 2 or 3 arm devices, the heave structure is at least partially hollow.

It is now disclosed for the first time a method for constructing a system to harvest energy from waves, comprising:

providing a base structure, with at least two sides, fixed to a base in or adjacent to waves,
providing a floating heave structure, with at least two sides,
providing at least two arm devices, each arm device comprising:

a base joint of either the prismatic or revolute types attached to a side of the base structure facing the heave structure,

a heave joint of either the prismatic or revolute types attached to a side of the heave structure facing the base structure, said heave joint corresponding substantially to a position of the base joint on the base structure,

each base joint is attached to a base arm,

each heave joint is attached to a heave arm,

each pair of base and heave arms is attached to a middle joint;

each arm device is connected to at least one generator system, said generator system defined as any mechanism that results in energy production, such as hydraulic or electrical, from the motion of the arm device.

In one embodiment, the system further comprises at least 3 arm devices.

According to another embodiment of the system of 2 or 3 arm devices, the method further comprises:

obtaining wave data comprising height of waves in a particular location over time,
determining a standard wave height, based on one of a group of average, median, or mode of the wave heights in a designated area,
setting the fully extended height of the arm devices for a particular location as at least double the standard wave height.

### BRIEF DESCRIPTION OF SEVERAL VIEWS OF THE DRAWINGS

The invention is herein described, by way of example only, with reference to the accompanying drawings, wherein:

FIG. 1 is a diagram of 3 three-degree-of-freedom arm devices attached to base and heave structures.

FIG. 2 is a diagram of a platform with straight hydraulic connections.

FIG. 3 is a diagram of surfaces of a concave heave structure.

FIGS. 4-7 illustrate prior art.

FIG. 8 is a diagram of prismatic and revolute joints.

FIG. 9 is a diagram of different possible movements of a three-degree-of-freedom device.

FIG. 10 is an outline of the method of evaluating a site for a three-degree-of-freedom device.

FIG. 11 is a diagram of several devices operating with different maximal and minimal wave height.

### DETAILED DESCRIPTION OF THE INVENTION

The principles and operation of a wave energy converter according to the present invention may be better understood with reference to the drawings and the accompanying description.

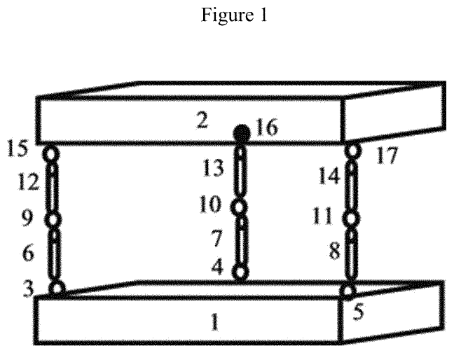

Referring now to the drawings, FIG. 1 illustrates a three-degree-of-freedom device. (1) is the base structure and (2) is the heave structure. Joints attached to the base structure are (3,4,5). Joints attached to the heave structure are (15,16,17). Note that (16) is really not seen from this perspective. The joints on the base structure are ideally substantially aligned vertically with the joints on the heave structure. Each base joint is attached to an arm (6,7,8). Each heave joint is attached to an arm (12,13,14). The base and heave arms meet in a middle joint (9,10,11). An example of an arm device would be (3,6,9,12,15). Three arm sets provide limitations in 3 dimensions over the motion of the heave structure.

A base structure does not necessarily have to be below the heave structure.

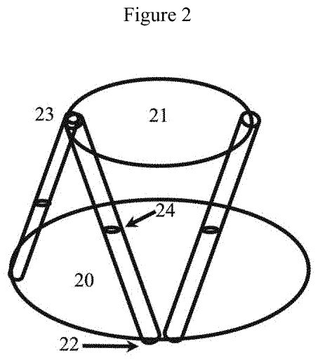

FIG. 2 shows an example of a three-degree-of-freedom device with more arms than are necessary for the current invention, since the figure, for the sake of clarity, shows only 3 of the 6 arms. This is a Stewart's platform, which is made for robotics controls, otherwise an example of the current invention's configuration, except for the facts that it is made for movement under human control, not for absorption of energy from a rolling wave, and thereby consumes rather than produces energy, and that for the current application, three arm devices are adequate. More than 3 are unnecessary. (20) is the base structure and (21) is the upper platform, or what would be termed in this invention, a heave structure. It is also different from the current application as all its joints are the RPR type. (22) is the base joint, (23) is the heave joint, and (24) is the middle joint, connecting two arms. The middle joint (24) is an example of a prismatic or sliding joint. A Stewart platform is limited to such a RPR joint. To our knowledge, no one has utilized the concept of the control available from robotics configurations to use them backwards to enable waves to drive a harvesting of mechanical or hydraulic energy.

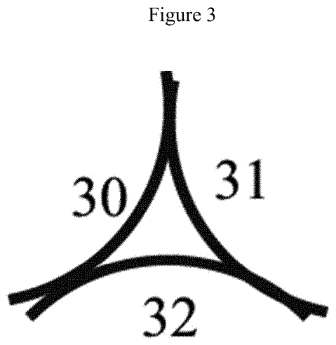

FIG. 3 shows a variation of the heave structure with a concave surface. An important point is that the heave structure does not have to be tabular. Because the other heave structures shown for this invention and other heave inventions of prior art have a flat or convex surface, efficiency can be lost by water sliding over them. A cupped and concave surface is likely to be more efficient and capture more energy. Elements (30,31,32) show one embodiment of that. The tabular or polyhedral structure of whatever shape can have variable thickness. We have found that such variation can be associated with different efficiencies.

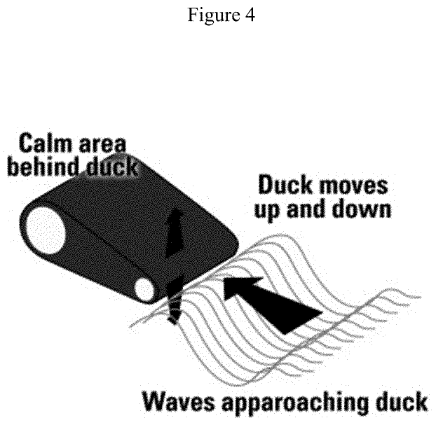

FIG. 4 is an illustration of how a Salter's Duck turbine works.

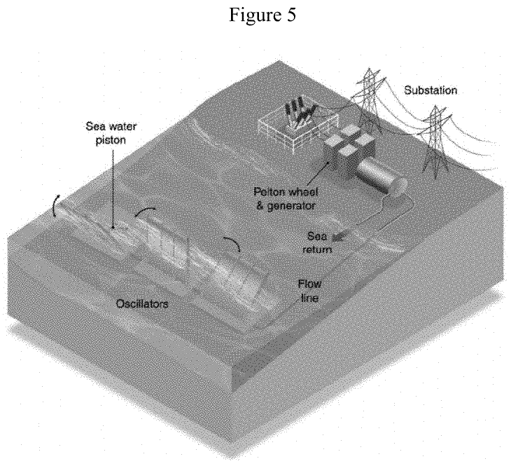

FIG. 5 illustrates an oscillating system.

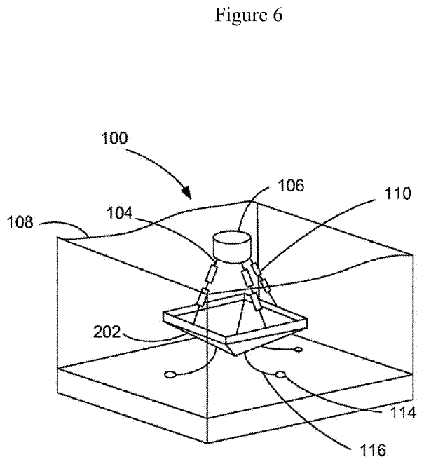

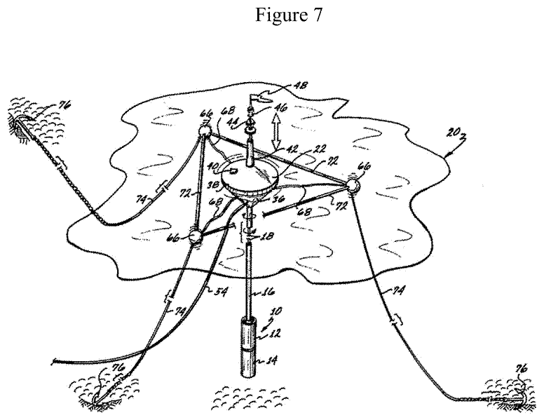

FIG. 6 illustrates a buoy system. FIG. 7 illustrates another buoy system. The limitation of a buoy system is that it moves only up and down and misses the rolling force of the waves.

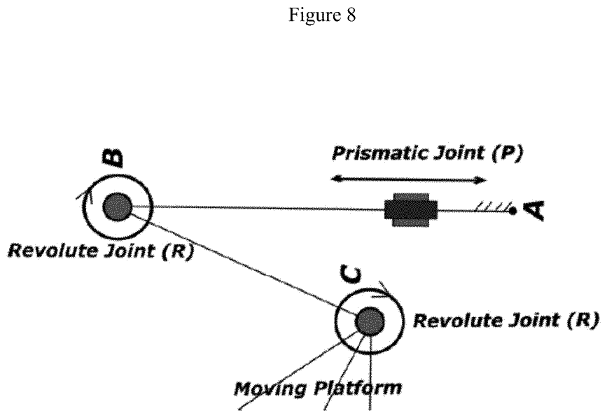

FIG. 8 illustrates the definition of the joints.

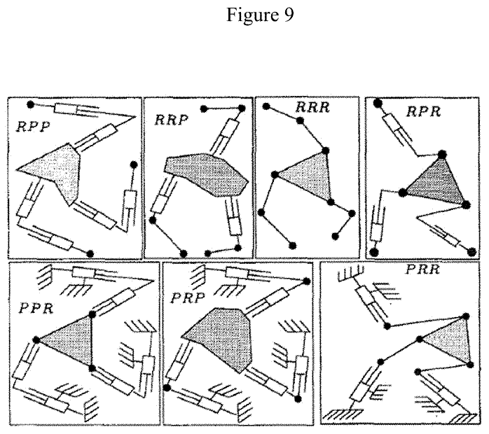

FIG. 9 shows the variety of combinations of joints to make a three-degree-of-freedom device. It illustrates the common abbreviations of the likely combinations. One can see the flexibility of these different configurations in terms of being able to respond to the non-linear motion of waves.

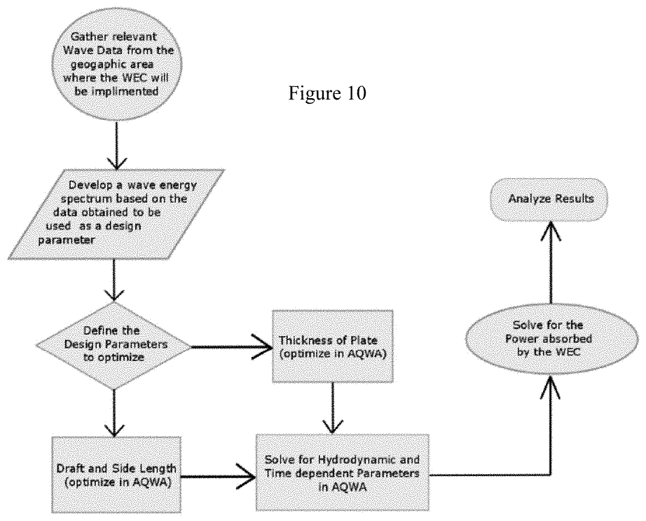

FIG. 10 shows the process of customizing the concept for a particular site in the ocean. This involves obtaining data on the average, median, and mode of a particular location, using that information to decide on a standard wave height to use as the basis to design a project, and picking a design point for the system, which will usually be double the standard wave height so that one can cover the ranges from zero to a large majority of the wave heights. Alternatively, one may use this distribution to maximize energy obtained by choosing a point higher than the standard wave height for the design of the system if there are a lot of higher waves in that location. Since power is proportional to wave height squared, there is more to be gained in terms of total power by capturing the higher end of the spectrum, depending on the total cost-effectiveness of making a higher capacity turbine. In some circumstances, moderate amounts of power delivered consistently are more the desires of the customer, in which case the best choice is to double the standard wave height in determining maximum height of the upper structure.

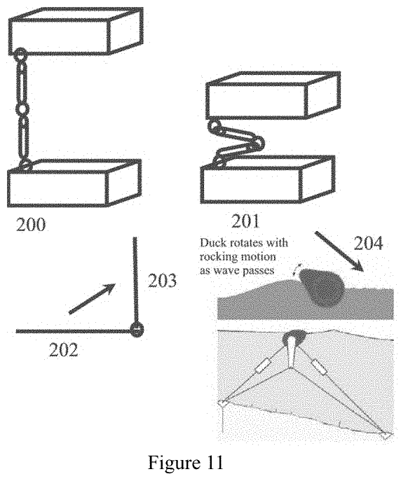

FIG. 11 illustrates how the current invention compares with other technologies. The potential advantage of this is not only an increase in efficiency for a particular wave, but it addresses a limitation of heave devices—that they are efficient for a particular wave height but cannot “stretch” to change the wave height they can adjust to. A current-art heave converter that was made to work on 1-meter high waves will always be limited to 1 meter of a 2-meter wave, but the current invention can be made so it can bend according to a range of wave heights. If it is 1 meter when the joints are bent at 45 degrees, it can become 2 meters when the joints are at 90 degrees to the base structure. This variation is a normal feature of waves. Currently, a project developer might measure that 1-meter waves are the average in a location, and use a converter made for ideal performance for 1-meter waves. With the current invention, a developer can determine, for example, that the average waves are 1 meter but 90% of the time they vary from 0 to 3. Then the developer would order from the applicant a 3 points of freedom wave harvester whose maximum height is 3 meters, but which can bend to nearly zero.

In FIG. 11, assume a wave is coming from the left. Configuration (200) shows the current invention fully stretched up; (201) shows it at minimal height. This means it can handle a range of wave heights with equivalent efficiency. The Salter's duck, the archetypal heave device, has a single fixed height (204) and that is its optimal efficiency. The base plate of a clapper (202) is attached via a joint to a movable upper plate (203) in a common configuration for many types of wave turbines. Any variation of wave height over the ideal it was built for will add nothing to the energy harvesting. In addition, the joints allow the current invention to move with the waves and capture more of their motion.

Clearly, the base plate needs to be fixed at the time that the heave plate is moving. However, its height from the sea floor can be adjustable. There are many reasons to adjust it, such as taking advantage of higher waves, adjusting to differences in surface height during tides, or purposely submerging it during dangerous storms.

The way in which the current invention produces useful energy is not the focus of this application. Clearly, cables connected to gears and the use of compressed fluids can convert the motion of the wave harvester into useful mechanical energy and/or pressure and then electricity.

While the invention has been described with respect to a limited number of embodiments, it will be appreciated that many variations, modifications and other applications of the invention may be made.

1. A system for obtaining energy from waves, comprising:
a base structure, with at least two sides, fixed to a base in or adjacent to waves,
a floating heave structure, with at least two sides, said heave structure substantially submerged by the water,
three arm devices, each arm device comprising:
a base joint of either a prismatic P or revolute R types attached to a side of the base structure facing the heave structure,
a heave joint of either the prismatic P or revolute R type attached to a side of the heave structure facing the base structure, said heave joint corresponding substantially to positions of the base joints on the base structure,
each base joint is substantially aligned vertically with a heave joint,
each base joint is attached to a base arm,
each heave joint is attached to a heave arm,
each pair of base and heave arms is attached to a middle joint of either the prismatic P or revolute R types;
each said arm device may have the configurations RRR, RRP, RPP, PRR, PRP, PPR,
each said arm device is connected to at least one generator system, said generator system defined as any mechanism that results in energy production, such as hydraulic or electrical, from the motion of the arm device.

2. (canceled)

3. The system of claim 1, wherein at least one generator system comprises a hydraulic mechanism containing a compressible fluid, said fluid compressed by the motion of the arms and joints.

4. The system of claim 1, wherein at least one arm device comprises an electric generator, operating from rotational motion of the joint.

5. The system of claim 1, wherein the base structure is below the heave structure.

6. The system of claim 5, wherein the base structure is between the upper part of the wave on the surface and the lower point of the wave, beneath the surface.

7. The system of claim 1, wherein the base structure is adjustable in height above the sea floor while fixed to a supporting object.

8. The system of claim 5, wherein a second heave structure is attached by arm devices to a second side of the base structure.

9. The system of claim 1, wherein the heave structure is substantially planar.

10. The system of claim 1, wherein the heave structure is a polygonal structure

11. The system of claim 1, wherein at least one part of the heave structure is concavely cupped in the area of impact of the wave on the heave structure,

12. The system of claim 1, wherein a length of the heave structure is equal to or a little greater than the wavelength of the wave.

13. The system of claim 1, wherein the heave structure is at least partially hollow.

14. A method for constructing a system to harvest energy from waves, comprising:
providing a base structure, with at least two sides, fixed to a base in or adjacent to waves,
providing a floating heave structure, with at least two sides, said heave structure substantially submerged by the water,
providing three arm devices, each arm device comprising:
a base joint of either a prismatic or revolute type attached to a side of the base structure facing the heave structure,
a heave joint of either the prismatic or revolute types attached to a side of the heave structure facing the base structure, said heave joint corresponding substantially to a position of the base joint on the base structure,
each base joint is substantially aligned vertically with a heave joint,
each base joint is attached to a base arm,
each heave joint is attached to a heave arm,
each pair of base and heave arms is attached to a middle joint of either the prismatic P or revolute R types;
each said arm device may have the configurations RRR, RRP, RPP, PRR, PRP, PPR,
each arm device is connected to at least one generator system, said generator system defined as any mechanism that results in energy production, such as hydraulic or electrical, from the motion of the arm device.

15. (canceled)

16. The method of claim 14, further comprising:
obtaining wave data comprising height of waves in a particular location over time,
determining a standard wave height, based on one of a group of average, median, or mode of the wave heights in a designated area,
setting the fully extended height of the arm devices for a particular location as at least double the standard wave height.
